(19) United States
(12) Patent Application Publication
(10) Pub. No.: US 2004/0029011 A1
(43) Pub. Date: Feb. 12, 2004

(54) Cathode compositions and use thereof, particularly in electrochemical generators

(76) Inventors: Nathalie Ravet, Montreal (CA); Michel Armand, Montreal (CA)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/275,284

(22) PCT Filed: Mar. 13, 2002
(86) PCT No.: PCT/CA02/00341

(30) Foreign Application Priority Data
Mar. 13, 2001 (CA) 2,340,798

(51) Int. Cl. H01M 4/58; H01M 4/62

(52) U.S. Cl. 429/231.95; 429/221; 429/224; 429/232

(57) ABSTRACT

Composition of positive electrode containing at least one mixed oxide of spinal or lamellar structure having the general formula Li₁₋ₓM_{1-y}AₐO_{2-f}F_{f}, and at least one mixed phosphate of the general formula Li_{1-z}FeₙMnₘPO₄ and in which:

M=Co, Ni, Mn,

A=Mg, Zn, Al, Fe, Cr, Co, Mn, Ni, Zn Ga,

0≦x, y, a, f≦1,

0<z, n, m ≦1,

and which operates within the voltage range 4.3 V [symbol] 2.5 V with a voltage plateau located between these two values.

### TECHNICAL FIELD

The present invention concerns new cathodic compositions and their uses, for example in electrochemical generators. The invention also concerns electrochemical cells including at least one electrode comprising a composition according to the invention.

### BACKGROUND ART

Compounds for positive electrodes of spinel or lamellar structure of general formula Li1₋ₓM1_{-y}AₐO_{2-f}F_{f} in which

M=Co, Ni, Mn,

A=Mg, Zn, Al, Fe, Cr, Co, Mn, Ni Zn, Ga

0≦x, y, a, f≦1,

are known (J.-M. Tarascon, M. Armand, Nature, volume 414, Nov. 15, 2001, pp 359-367).

These materials operate within the voltage range 3.9-4.2 V vs Li:Li⁺ however on the one hand they call for use of rare elements (Co) or present stability problems (Ni, Mn) which limit the life span of batteries using them. Another disadvantage is the low massic capacity of these materials, which is between 90 and 130 mAh/g. These materials are used in the field of electronics and a voltage norm of 4.1-4.2 V is required in most of the portable electronic systems.

On the other hand, the compound Li_{1-z}Fe₁₋ₘMnₘPO₄ (0≦z, m≦1) (U.S. Pat. No. 5,910,382) is known. These compounds possess redox properties of the type insertion-deinsertion of lithium. The capacity is essentially higher, of the order of 170 mAh/g and the discharge/discharge curve is at a constant voltage 3.3-3.5 V and 4.2-4.4 V vs Li:Li⁺ for the couples respectively bound to iron and manganese. Moreover, these materials are non toxic and are formed from abundant elements. On the other hand, operating in a very narrow voltage range is an advantage in terms of simplifying the electronic, so much so that the resistance of these materials towards overcharge and over-discharge is excellent. However, these materials have an electronic conductivity which is too weak and require the addition of either an important massic fraction of carbon for use in primary or secondary generators, or a deposit of an extremely thin carbonated material, that is distributed on the surface of the grains. In this case, the apparent density, therefore the connectivity of the grains, should be the highest so as to obtain a good electronic exchange. This means that important volumic fractions of double phosphate are required in the composite material that is used as cathode.

### DISCLOSURE OF INVENTION

The invention concerns a composition for positive electrode containing at least one mixed oxide of spinel or lamellar structure or general formula Li₁₋ₓM_{1-y}AₐO_{2-f}F_{f} in which

M=Co, Ni, Mn

A=Mg, Zn, Al, Fe, Cr, Co, Mn, Ni Zn, Ga

0≦x, y, a, f≦1.

0≦z, n, m≦1,

and whose operation is within the voltage range 4.3 V [symbol] 2.5 V with a voltage plateau located between these two values.

The mixed oxide is preferably Li₁₋ₓCoO₂ or Li₁₋ₓNi_{1-y}Co_{y}O₂ in which 0.1≦y≦0.4, while the mixed phosphate is preferably Li_{1-z}FeₙMnₘPO₄ in which 0≦y≦0.4 and with one of the voltage plateau in the zone 3.3 V [symbol] 3.5 V.

According to a preferred embodiment, the proportion of mixed phosphate with respect to the mixed oxide is between 5 and 95 weight percent, preferably between 20 and 80 weight percent.

According to another embodiment, the mixed phosphate may have its surface covered with an homogeneous conductor deposit based on carbon or of a pyrolyzed organic material.

According to another embodiment, a polymer which acts as a binder and possibly as electrolytic conductor by the addition of a salt containing at least in part lithium ions, and possibly a polar liquid, may be added to the active cathodic mixture.

According to another embodiment, an electronic conductor enabling exchanges between the current collector and the particles of electrode material, such as carbon black, graphite or mixture thereof, may be added to the active cathodic mixture.

The invention also concerns an electrochemical cell comprising at least one electrode containing at least one material consisting of a composition as defined above.

According to an embodiment of the invention, this electrochemical cell comprises a positive electrode having a composition as defined above, and it operates as a primary or secondary battery, or as a super-capacity.

As used as a primary or secondary battery, according to another embodiment, the electrolyte is a solvating or non solvating polymer, possibly plastified or gelified with a polar solvent and containing in solution one or more metallic salts, in particular a lithium salt. The electrolyte may also be a polar liquid, containing in solution one or more metallic salts, such as a lithium salt, possibly immobilized in a microporous separator, in particulary a polyolefin, a polyester, nanoparticles of silica, alumina or lithium aluminate LiAlO₂ or a mixture thereof in the form of composite.

The polymer containing a salt and possibly a polar liquid is preferably formed from oxyethylene, oxypropylene, acrylonitrile, vinylidene fluoride, acrylic or methacrylic acid ester units, units derived from itaconic acid esters with alkyl or oxa-alkyl goups, in particular oxyethylene units.

According to another embodiment of the invention, the polymer contains for example powders of nanoparticles such as silica, titanium oxide, alumina, LiAlO₃.

The polar liquid is preferably selected from cyclic or linear carbonates, carboxylic esters, alpha-omega ethers of oligoethylene glycols, N-methylpyrrolidinone, gamma-butyrolactone, tetra-alkylsulfamides and mixtures thereof, a portion of the hydrogene atom being possibly substituted with fluorine atoms.

According to another embodiment, the negative electrode of the battery according to the invention may contain metallic lithium or one of its alloys, and in particular with aluminum, carbon containing an insertion compound of lithium, in particular graphite or pyrolitic carbones LiFeO₂, Li₄Mn₂O₄ or Li₄Ti₅O₁₂ or solid solutions formed with these oxides.

According to another embodiment, the current collector of the electrode containing the electrode material according to the invention is made of aluminum, possibly in the form of spreaded or expanded metal.

According to another embodiment, the power that can be delivered with these systems is superior to the one obtained with oxides used alone in the cathodic mixture, in particular when very high powers are required.

### BRIEF DESCRIPTION OF DRAWINGS

FIG. 1 represents shapes of charge and discharge curves obtained under different operating conditions at room temperature for LiCoO₂ and LiFePO₄ batteries.

FIG. 2 represents shapes of charge and discharge curves obtained under different operating conditions at room temperature for batteries containing a mixture consisting of 72% LiCoO₂ and 28% LiFePO₄.

FIG. 3 represents the evolution of the capacity supplied as a function of the charge and discharge current intensity for batteries containing LiCoO₂ (between 4.1 and 3 V) and LiFePO₄ (between 4.1 and 2.5 V) and containing a mixture comprising 72% LiCoO₂ and 28% LiFePO₄ (between 4.1 and 2.5V and between 4.1 and 3 V).

FIG. 4 represents the shapes of charge and discharge curves of batteries containing LiMn₂O₄ on the one hand, and a mixture of LiMn₂O₄ and LiFePO₄ on the other hand.

### MODES OF CARRYING OUT THE INVENTION

In the present invention, it is shown that electrodes containing one or a mixture of the two families of electrode materials mentioned above, double oxides or double phosphates may advantageously operate, whether in terms of capacity or available power. This behavior in unexpected in regard to the dilution and the decrease of the contacts between particles of phosphate that these mixtures comprise. Indeed, the particles of phosphate based materials are very poor conductors and cannot ensure a continuity of elevated electronic conductivity in the mixture, which is a required condition for a rapid electrochemical kinetic. The conductive coating possibly deposited at the surface of the phosphate particles describe in U.S. Pat. No. 5,910,382 and which improves surface conductivity is extremely thin, and although it contributes to establish a homogeneous electrical field at the surface of the phosphate particles, it cannot operate to transfer and drain currents produced by the oxide particles of the mixture.

The advantages associated with the use of these mixture are numerous:

because of the presence of a high voltage oxide, the systems using these mixtures may be directly substituted for existing electronic systems;

the capacity is increased;

cost and toxicity are reduced so much more that the volumic fraction of the high capacity material is higher;

the addition of an oxide having semi-conducting properties facilitates the current collection of the less conductive second compound such as iron phosphate, and the use of the composite electrode and its electrochemical performance because it requires lesser addition of electronic conductive material;

the existence of a wide range of operation where the voltage is independent of the state of charge of the battery is an advantage in terms of energy efficiency;

thermal stability is increased because of the dilution of the reactive phase towards the electrolyte, i.e. the mixed oxide, with a compound that is inert towards this same electrolyte.

In a manner that is also surprising, it appears that a synergic effect is obtained. It has indeed been observed that the power which can be delivered with these systems is higher to the one obtained with the oxides taken alone under comparable conditions, in particular when very high powers are required from the generators/supercapacities. This latter mentioned phenomenon is important in as much as the main applications directed to the electronic markets require high powers at low temperature, for example, for cell phones.

### EXAMPLES

The characteristics of the invention will now be illustrated by means of the examples which follow given by way of illustration and without limitation.

### Example 1

### Cathode Comprising a Mixture of LiFePO₄ and LiCoO₂

The electrochemical performances of a battery containing a liquid electrolyte, a lithium anode and in which the active material of the cathode consists of a mixture of 28% LiFePO₄ and 72% LiCoO₂ were studied at room temperature. The theoritical to the capacity of such a mixture is 146 mAh.g⁻¹. For comparison purpose, similar batteries containing LiFEPO₄, on the one hand, and LiCoO₂ on the other hand were also assembled.

The cathodes are made of a mixture of active material, carbon black and a binding agent (PVDF in solution in N-methylpyrolidone) in the ratios 85:5:10. The composite is spreaded on an aluminum current collector. After drying, electrodes measuring 1.3 cm² and having a capacity of about 1.6 mAh are stamped out. The batteries were assembled in a glove box, under an inert atmosphere.

Measurements were made in an electrolyte containing LiClO₄ 1M in a mixture EC:DMC 1:1. The anode consists of lithium. Tests were carried out at room temperature.

The batteries containing LiCoO₂ alone as well as the mixture were charged in galvanostatic mode up to 4.1 V while keeping the voltage stable until the current is lower than 25 micro-amperes. The battery containing LiFePO₄ was generally charged until reaching 4.1 V except for the operating condition 5C where a stable voltages was maintained.

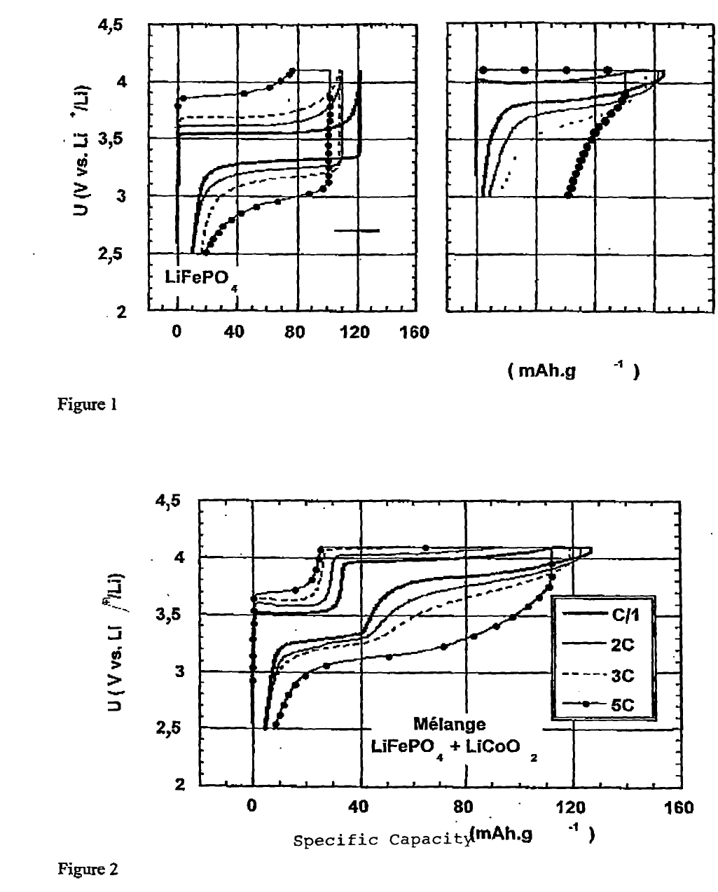

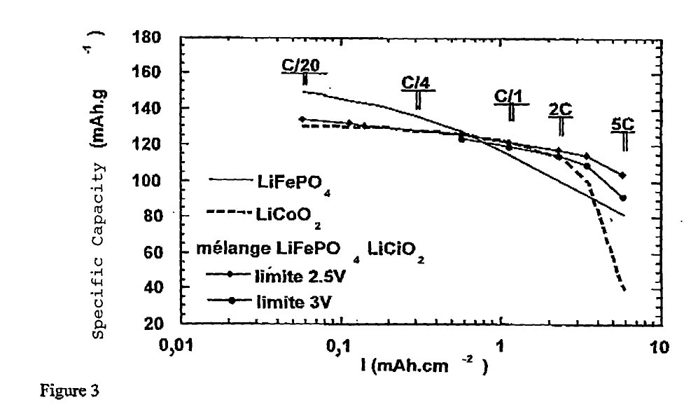

The shapes of charge and discharge curves at different operating conditions are presented in FIG. 1 for the separate compounds and in FIG. 2 for the mixture. The specific capacities obtained in each case are reported in FIG. 3. For the mixture, the capacities were noted for two different voltage limit discharges: 3 V and 2.5 V.

For operations at lower than 3C, the shapes obtained for the mixture follow the behavior of each of the separate components and clearly show the electrochemical activity of the two materials. The capacities of the mixture, as well as their evolution as a function of the current used are close to those of LiCoO₂. From 3C the specific capacities obtained for the mixture are superior to those of the separate components. At 5C, the discharge curve is completely different from those of LiFePO₄ and LiCoO₂. The capacity supplied by this mixture containing 72% cobalt oxide is twice that of LiCoO₂ alone.

### Example 2

One of the most interesting materials for the cathode of lithium batteries, is manganese spinel LiMn₂O₄. This material is cheap, abundant and non toxic. Theoretically, it has two domains of operation: one at 4 volts and the other at 3 volts respectively corresponding to the couple Mn₂O₄/LiMn₂O₄ and LiMn₂O₄/Li₂Mn₂O₄. Unfortunately, a rapid loss of the reversible capacity is observed when the battery is cycled in the two domains. This phenomenon which is still not well understood is often explained by a loss of electrical contact between the particles. The latter would appear to be due to an important change of volume associated with a distortion of the crystal of Li₂Mn₂O₄. For this reason, manganese spinel can only be cycled at about 4 volts. It also appears important to be able to protect the battery from an over-discharge by preventing the reduction of LiMn₂O₄ in Li₂Mn₂O₄. This protection may be carried out by adding to the cathode a reversible insertion material whose activity is between those of the two couples of manganese spinel.

### Cathode Made of a Mixture of LiFePO₄ and LiMn₂O₄

The electrochemical behavior of a battery containing a liquid electrolyte, a lithium anode and in which the active material of the cathode consists of a mixture of 23% LiFePO₄ and 77% LiMn₂O₄ was studied at room temperature. For comparison purpose, a similar battery containing LiMn₂O₄ was also assembled. The cathodes were made of a mixture of active material, carbon black and a binding agent (PVDF in solution N-methylpyrolidone) in the ratio 90:3:7. The composite is spreaded on a current collector made of aluminum. After drying, electrodes having a surface of 1.3 cm² and containing about 11 mg of active material, are prepared by stamping out. The batteries are assembled in a glove box under an inert atmosphere.

Measurements are made in an electrolyte containing LiClO₄ 1M in mixture EC:DMC 1:1. The anode consists of lithium. The tests were made at room temperature.

The batteries were charged up to 4.2 V and discharged to 2.5 V at a current of 400 μA.

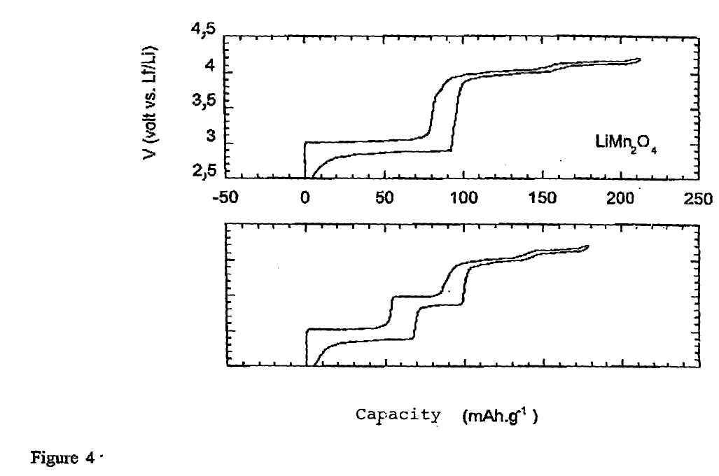

FIG. 4 shows the shapes of charge and discharge for LiMn₂O₄ alone and for the mixture LiMn₂O₄ LiFePO₄. The activity of LiFePO₄ is between the two couples of manganese spinel and is clearly different from the two plateaux of the latter.

By adding a reversible capacity between the two plateaux of LiMn₂O₄ the risk of overdischarge are limited which should increase the reliability of these devices.

It is understood that the invention is not restricted to the preferred embodiments defined above and that it also comprises any modifications provided that the latter are covered by the annexed claims.

1. Composition for a positive electrode characterized in that it contains at least one mixed oxide of spinel or lamellar structure, having the general formula Li₁₋ₓM_{1-y}AₐO_{2-f}F_{f}, and at least one mixed phosphate of general formula Li_{1-z}FeₙMnₘPO₄ and in which:
M=Co, Ni, Mn,
A=Mg, Zn, Al, Fe, Cr, Co, Mn, Ni, Zn Ga
0≦x, y, a, f≦1,
0≦z, n, m≦1,
and which operates within the voltage range of 4.3 V [symbol] 2.5 V with a voltage plateau located between these two values.

2. Composition for a positive electrode according to claim 1, characterized in that the mixed oxide is Li₁₋ₓCoO₂ or Li₁₋ₓNi_{1-y}Co_{y}O₂ in which 0.1≦y≦0.4.

3. Composition for a positive electrode according to claim 1, characterized in that the mixed of phosphate is Li_{1-z}FeₙMnₘPO₄ in which 0≦y≦0.4 and one of the voltage plateaux is within the zone 3.3 V [symbol] 3.5 V.

4. Composition for a positive electrode according to claim 1, characterized in that the proportion of mixed phosphate with respect to the mixed oxide is between 5 and 95 weight %.

5. Composition for a positive electrode according to claim 4, characterized in that the proportion of mixed phosphate with respect to the mixed oxide is between 20 and 80 weight %.

6. Composition for a positive electrode according to claim 1 characterized in that the mixed phosphate is covered on its surface with a carbon based homogeneous conductive deposit or a pyrolyzed organic material.

7. Composition for a positive electrode according to claim 1, characterized in that the active cathodic mixture has added thereto, a polymer used as a binder and possibly as electrolytic conductor by the addition of a salt containing at least in part lithium ions and possibly a polar liquid.

8. Composition for a positive electrode according to claim 1, characterized in that the active cathodic mixture has added thereto, an electronic conductive material enabling exchanges between the current collector and the particles of the material of the electrode.

9. Composition for a positive electrode according to claim 8, characterized in that the electronic conductor enabling exchanges between the current collector and the particles of the material of the electrode is carbon black, graphite or a mixture thereof.

10. Electrochemical cell characterized in that it comprises at least one electrode containing at least one material according to claim 1.

11. Electrochemical cell characterized in that it comprises a positive electrode comprising a composition as defined in claim 1, and in that it operates as a primary or a secondary battery, or as a super-capacity.

12. Primary or secondary battery according to claim 11, characterized in that the electrolyte is a solvating or a non-solvating polymer, possibly plastified or gelified with a polar solvent and containing in solution one or more metallic salts, in particular a lithium salt.

13. Primary or secondary battery according to claim 11, characterized in that the electrolyte is a polar liquid and contains in solution one or more metallic salts, possibly immobilized in a microporous separator in particular a polyolefin, a polyester, nanoparticles of silica, alumina or lithium aluminate LiAlO₂ or a mixture thereof in the form of composite.

14. Primary or secondary battery according to claims 12 and 13, characterized in that one of the metallic salts is a litium salt.

15. Battery according to claim 12 characterized in that the polymer containing a salt and possibly a polar liquid is formed from oxyethylene, oxypropylene, acrylonitrile, vinylidene fluoride units, acrylic or metacrylic acid ester units, itaconic acid ester units with alkyl or oxa-alkyl group, in particular containing oxyethylene units.

16. Battery according to claim 15, characterized in that the polymer contains powders of nanoparticles such as silica, titanium oxide, alumina, LiAlO₃.

17. Battery according to claims 12 to 16, characterized in that the polar liquid is selected from cyclic or linear carbonates, carboxylic esters, alpha-omega ethers of oligoethylene glycols, N-methylpyrrolidinone, gamma-butyrolactone, tetra-alkylsulfamides, and mixtures thereof, a part of the hydrogen atoms possibly being substituted with fluorine atoms.

18. Battery according to claims 11 to 17 characterized in that the negative electrode contains metallic lithium or one of its alloys and in particular with aluminum, an insertion compound of lithium in carbon, in particular graphite or pyrolitic carbons, LiFeO₂, Li₂Mn₂O₄ or Li₄Ti₅O₁₂ or solid solution formed between these two oxides.

19. Battery according to claims 11 to 16 characterized in that the current collector of the electrode containing the electrode material according to claim 1 is made of aluminum, possibly in spreaded or expanded form.

20. Battery according to claims 11 to 15 characterized in that the power which can be delivered with these systems, is superior to the one obtained with oxides used alone in the cathodic mixture, in particular when very high powers are required.
